(19) United States
(12) Patent Application Publication
(10) Pub. No.: US 2007/0073638 A1
(43) Pub. Date: Mar. 29, 2007

(54) System and method for using soft links to managed content

(75) Inventors: Ryan Sean McVeigh, Broomfield, CO (US); Steven L. Roth, Westminster, CO (US); Jalpesh Patadia, Boulder, CO (US); Tanya Saarva, Boulder, CO (US); Xiaojiang Zhou, Broomfield, CO (US); Brad Posner, Erie, CO (US)

Correspondence Address: FLIESLER MEYER LLP, 650 CALIFORNIA STREET, 14TH FLOOR, SAN FRANCISCO, CA, 94108, US

(73) Assignee: BEA Systems, Inc., San Jose, CA (US)

(21) Appl. No.: 11/526,942

(22) Filed: Sep. 26, 2006

Related U.S. Application Data
(60) Provisional application No. 60/720,860, filed on Sep. 26, 2005.

(51) Int. Cl. G06F 17/30; G06F 7/00; G06F 17/00

(52) U.S. Cl. 707/1; 715/501.1; 707/100

(57) ABSTRACT

A system and method for using soft links to managed content is described, wherein data is stored within a content repository in the form of nodes arranged in a hierarchical structure. Soft links are created and associated with content nodes by having a reference pointer to a node that is resolved by the content repository. A soft link may be implemented as a skeleton node containing no actual storage data except to point to the actual content node. Nested soft links are also supported wherein a soft link may reference another soft link which can reference a node or yet another soft link. Checks for cyclical infinite loops can be performed. Soft links can be presented as pointers to regular content nodes to the users. This can enable users to arrange and customize data while saving on storage costs and preventing duplication of data.

### CLAIM OF PRIORITY

This application claims the benefit of U.S. Provisional Patent Application No. 60/720,860 entitled IMPROVED CONTENT MANAGEMENT, by Ryan McVeigh et al., filed Sep. 26, 2005 (Attorney Docket No. BEAS-01968US0), the entire contents of which are incorporated herein by reference.

### CROSS REFERENCE TO RELATED APPLICATIONS

The following commonly owned, co-pending U.S. patents and patent applications, including the present application, are related to each other. Each of the other patents/applications are incorporated by reference herein in its entirety:

U.S. patent application Ser. No. 11/438,164 entitled SYSTEM AND METHOD FOR PROVIDING LINK PROPERTY TYPES FOR CONTENT MANAGEMENT, by Ryan McVeigh et al., filed on May 22, 2006, Attorney Docket No. BEAS-1881US0;

U.S. patent application Ser. No. 11/438,202 entitled SYSTEM AND METHOD FOR TYPE INHERITANCE FOR CONTENT MANAGEMENT, by Ryan McVeigh et al., filed on May 22, 2006, Attorney Docket No. BEAS-1879US0; and

U.S. patent application Ser. No. 11/438,593 entitled SYSTEM AND METHOD FOR PROVIDING NESTED TYPES FOR CONTENT MANAGEMENT, by Ryan McVeigh et al., filed on May 22, 2006, Attorney Docket No. BEAS-1880US0.

U.S. patent application Ser. No. XX/XXX,XXX entitled SYSTEM AND METHOD FOR PROVIDING FULL TEXT SEARCHING OF MANAGED CONTENT, by Ryan McVeigh et al., filed on Sep. 26, 2006, Attorney Docket No. BEAS-1877US0.

U.S. patent application Ser. No. XX/XXX,XXX entitled SYSTEM AND METHOD FOR PROVIDING FEDERATED EVENTS FOR CONTENT MANAGEMENT SYSTEMS, by Ryan McVeigh et al., filed on Sep. 26, 2006, Attorney Docket No. BEAS-1887US0.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to managing content for use with portals and other content delivery mechanisms, and more particularly to a mechanism for using soft links within content repositories.

### BACKGROUND

Content repositories manage and provide access to large data stores such as a newspaper archives, advertisements, inventories, image collections, etc. A content repository can be a key component of a web application such as a portal, which must quickly serve up different types of content in response to user interaction. However, difficulties can arise when trying to integrate more than one vendor's content repository. Each may have its own proprietary application program interface and content services (e.g., conventions for searching and manipulating content, versioning, lifecycles, and data formats). Furthermore, each time a repository is added to an application, the application software must be modified to accommodate these differences. What is needed is a coherent system and method for interacting with disparate repositories and for providing a uniform set of content services across all repositories, including those that lack such services.

### BRIEF DESCRIPTION OF THE DRAWINGS

FIG. 1 is an exemplary illustration of functional system layers in various embodiments.

FIG. 2 is an exemplary illustration of objects/interfaces that can be used to interface repositories comprising content in various embodiments.

FIG. 3 is an exemplary illustration of soft links within a content repository, in accordance with various embodiments.

FIG. 4 is an exemplary flow diagram illustration of using soft links for managed content within a repository, in accordance with various embodiments.

FIG. 5 is a hardware block diagram of an example computer system, which may be used to embody one or more components in an embodiment.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device/appliance such as a router. Furthermore, it can also be apparent to those skilled in the art that such components, regardless of how they are combined or divided, can execute on the same computing device or can be distributed among different computing devices connected by one or more networks or other suitable communication means.

In accordance with various embodiments, there are presented systems and methods for using soft links to managed content. A content repository is described, wherein data is stored in the form of nodes arranged in a hierarchical structure. Soft links are created and associated with content nodes by having a reference pointer to a node that is resolved by the content repository. A soft link may be implemented as a skeleton node containing no actual storage data except to point to the actual content node. Nested soft links are also supported wherein a soft link may reference another soft link which can reference a node or yet another soft link. Checks can be performed in order to prevent any cyclical infinite loops when using nested soft links. A soft link can be presented as a pointer to a regular content node for the users. This can enable users to arrange and customize data while saving on storage costs and preventing duplication of data.

As used herein, the term inheritance (or extension) is defined as when an object extends or inherits from a parent object, it gains the functionality as described by that parent object. The object is also capable of modifying that functionality to suit the object's specific needs. For content types, the functionality that can be extended and/or modified is the parent type's property definitions. As used herein, the term subtype is defined as a content type that has extended another content type. This is typically the child in the parent-child relationship. As used herein, the term Supertype (or Base Type) is defined as a content type that has been extended by another content type. This is typically the parent in the parent-child relationship. As used herein, the term overload is defined as the process by which a user modifies a property definition specified by a supertype. As used herein, the term abstract type is defined as a type that cannot be “instantiated”. A user cannot create a node of an abstract type. An abstract type may serve to be extended by other types (which could then have nodes instantiated) or a nested type within another type. As used herein, the term container type is defined as a type that contains other types as part of its data model. As used herein, the term contained type is defined as a type that is modeled within another type. This is done by the container type creating a property definition of type “nested type” which refers to the type to be nested. As used herein, the term container instance is defined as a node that is an instance of a container type. As used herein, the term contained instance is defined as a “node” that represents the property values of the nested property type within a container node. As used herein, the term link property type is defined as type of property definition that specifies a link to another node in the content management system. As used herein, the term link source is defined as the node containing the link property type property. As used herein, the term link target is defined as the target node to which a link source node's link property refers. Multiple link source nodes may reference the same target node. Further, link sources can target multiple link target nodes.

While the present invention is described with reference to an embodiment in which techniques for using soft links to managed content are implemented in an application server in conformance with the J2EE Management Framework using executable programs written in the Java™ programming language, the present invention is not limited to the J2EE Management Framework nor the Java™ programming language. Embodiments may be practiced using other interconnectivity specifications or programming languages, i.e., JSP and the like without departing from the scope of the embodiments claimed. (Java™ is a trademark of Sun Microsystems, Inc.).

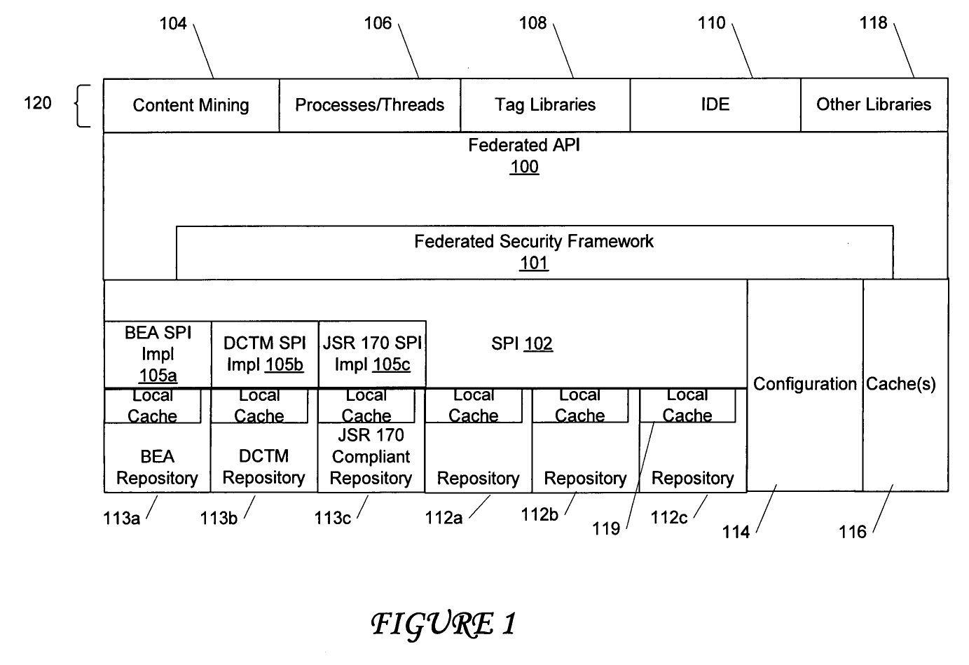

FIG. 1 is an exemplary illustration of functional system layers in various embodiments of the invention. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

A content repository 112 represents a searchable data store. Such systems can relate structured content and unstructured content (e.g., digitally scanned paper documents, Extensible Markup Language, Portable Document Format, Hypertext Markup Language, electronic mail, images, video and audio streams, raw binary data, etc.) into a searchable corpus. Content repositories can be coupled to or integrated with content management systems. Content management systems can provide for content workflow management, versioning, content review and approval, automatic content classification, event-driven content processing, process tracking and content delivery to other systems. By way of illustration, if a user fills out a loan application on a web portal, the portal can forward the application to a content repository which, in turn, can contact a bank system, receive notification of loan approval, update the loan application in the repository and notify the user by rendering the approval information in a format appropriate for the web portal.

A virtual or federated content repository (hereinafter referred to as “VCR”) is a logical representation of one or more individual content repositories. For example, the VCR provides a single access point to multiple repositories from the standpoint of application layer 120 but does not shield from the user that there is more than one repository available. The VCR can also add content services to repositories that natively lack them. Typically, the user interacts with the VCR by specifying which repository an action is related to (such as adding a new node), or performing an action that applies to all repositories (such as searching for content). In various embodiments and by way of illustration, this can be accomplished in part by use of an API (application program interface) 100 and an SPI (service provider interface) 102. An API describes how entities in the application layer can interface with some program logic or functionality. The application layer can include applications (and subdivisions thereof) that utilize the API, such as processes, threads, servlets, portlets, objects, libraries, and other suitable application components. An SPI describes how a service provider (e.g., a content repository, a content management system) can be integrated into a system of some kind. The SPI isolates direct interaction with repositories from the API. In various embodiments, this can be accomplished at run-time wherein the API library dynamically links to or loads the SPI library. In another embodiment, the SPI can be part of a server process such that the API and the SPI can communicate over a network. The SPI can communicate with the repositories using any number of means including, but not limited to, shared memory, remote procedure calls and/or via one or more intermediate server processes.

Content repositories may comprise a variety of interfaces for connecting with the repository. For example, as shown in FIG. 1, a BEA format repository 113a provided by BEA Systems, Inc. of San Jose, Calif., a Documentum format repository 113b, provided by EMC Corp. of Hopkinton, Mass., and a JSR-170 compliant repository 113c may be integrated into a VCR and made accessible via a single federated API 100 by SPI 102. Individual SPI implementations 105a, 105b, 105c provide format specific service provider interfaces to the BEA format repository 113a, the Documentum format repository 113b, and the JSR-170 format repository 113c, respectively. It is noteworthy that not all of the formats illustrated in FIG. 1 will be present in all embodiments. Further, some embodiments will include other repository formats not illustrated by FIG. 1 for brevity.

API's and SPI's can be specified as a collection of classes/interfaces, data structures and/or methods/functions that work together to provide a programmatic means through which VCR service(s) can be accessed and utilized. By way of illustration, APIs and SPIs can be specified in an object-oriented programming language, such as Java™ (available from Sun Microsystems, Inc. of Mountain View, Calif.) and C# (available from Microsoft Corp. of Redmond, Wash.). The API and SPI can be exposed in a number of ways, including but not limited to static libraries, dynamic link libraries, distributed objects, servers, class/interface instances, and other suitable means.

In various embodiments, the API presents a unified view of all repositories to the application layer such that navigation, CRUD operations (create, read, update, delete), versioning, workflows, and searching operations initiated from the application layer operate on the repositories as though they were one. Repositories that implement the SPI can “plug into” the VCR. The SPI includes a set of interfaces and services that support API functionality at the repository level. The API and SPI share a content model that represents the combined content of all repositories as a hierarchical namespace of nodes. Given a node N, nodes that are hierarchically inferior to N are referred to as children of N, whereas nodes that are hierarchically superior to N are referred to as parents of N. The top-most level of the hierarchy is termed the federated root. There is no limit to the depth of the hierarchy. In various embodiments, repositories are children of the federated root. Each repository can itself have children.

By way of illustration, content mining facilities 104, processes/threads 106, tag libraries 108, integrated development environments (IDEs) 110, and other libraries 118 can all utilize the API to interact with a VCR. An IDE can provide the ability for a user to interactively build workflows and/or content views. Content mining facilities can include services for automatically extracting content from the VCR based on parameters. Java ServerPages™ tag libraries enable portals to interact with the VCR and surface its content on web pages. (Java ServerPages™ is available from Sun Microsystems, Inc.) In addition, it will be apparent to those of skill in the art that many other types of applications and software components utilize the API and are, as such, fully within the scope and spirit of the present disclosure.

In various embodiments, the API can include optimizations to improve the performance of interacting with the VCR. One or more caches 116 can be used to buffer search results and/or recently accessed nodes. Some implementations may include additional cache 119 in one or more repositories. In various embodiments, a cache can include a node cache and/or a binary cache. A node cache can be used to provide fast access to recently accessed nodes whereas a binary cache can be used to provide fast access to the binary content/data associated with each node in a node cache. The API can also provide a configuration facility 114 to enable applications, tools and libraries to configure caches and the VCR. In various embodiments, this facility can be can be configured via Java Management Extension (JMX) (available from Sun Microsystems, Inc.).

In various embodiments, a model for representing hierarchy information, content and data types is shared between the API and the SPI. In this model, a node can represent hierarchy information, content or schema information. Hierarchy nodes can serve as containers for other nodes in the namespace akin to a file subdirectory in a hierarchical file system. Schema nodes represent predefined data types. Content nodes represent content/data. Nodes can have a shape defined by their properties. A property associates a name, a data type and an optional a value that is appropriate for the type. In certain of these embodiments, the properties of content nodes contain values. By way of an illustration, a type can be any of the types described in Table 1. Those of skill in the art will appreciate that many more types are possible and fully within the scope and spirit of the present disclosure.

TABLE 1
Exemplary Property Types in Various Embodiments

| PROPERTY TYPE | DESCRIPTION |
|---|---|
| Basic | Text, a number, a date/time, a Boolean value, |
| | a choice, an image, a sound, a bit mask, an |
| | audio/visual presentation, binary data. |
| Link | A pointer/reference to data that lives |
| | “outside” of a node. |
| Lookup | An expression to be evaluated for locating |
| | another node in the VCR |
| Database Mapped | Maps to an existing database table or view. |
| (or schema) | |
| Nested | One or more schemas define individual properties. |

In various embodiments, a property can also indicate whether it is required, whether it is read-only, whether it provides a default value, and whether it specifies a property choice. A property choice indicates if a property is a single unrestricted value, a single restricted value, a multiple unrestricted value, or a multiple restricted value. Properties that are single have only one value whereas properties that are multiple can have more than one value. If a property is restricted, its value(s) are chosen from a finite set of values. But if a property is unrestricted, any value(s) can be provided for it. A property can also be designated as a primary property. By way of illustration, the primary property of a node can be considered its default content. For example, if a node contained a binary property to hold an image, it could also contain a second binary property to represent a thumbnail view of the image. If the thumbnail view was the primary property, software applications such as browser could display it by default.

A named collection of one or more property types is a schema. A schema node is a place holder for a schema. In various embodiments, schemas can be used to specify a node's properties. By way of illustration, a Person schema with three properties (Name, Address and DateofBirth) can be described for purposes of discussion as follows:

Schema Person = {

<Name=Name, Type=Text>,
<Name=Address, Type=Address>,
<Name=DateofBirth, Type=Date>}

Various embodiments allow a node to be defined based on a schema. By way of illustration, a content node John can be given the same properties as the schema Person:
Content Node John is a Person

In this case, the node John would have the following properties: Name, Address and DateofBirth. Alternatively, a node can use one or more schemas to define individual properties. This is sometimes referred to as nested types. In the following illustration, John is defined having an Info property that itself contains the properties Name, Address and DateofBirth. In addition, John also has a CustomerId property:

Content Node John = {

<Name=Info, Type=Person>,
<Name=CustomerId, Type=Number> }

Schemas can be defined logically in the VCR and/or in the individual repositories that form the VCR. In certain embodiments, schemas can inherit properties from at least one other schema. Schema inheritance can be unlimited in depth. That is, schema A can inherit from schema B, which itself can inherit from schema C, and so on. If several schemas contain repetitive properties, a “base” schema can be configured from which the other schemas can inherit. For example, a Person schema containing the properties Name, Address and DateofBirth, can be inherited by an Employee schema which adds its own properties (i.e., Employee ID, Date of Hire and Salary):

Schema Employee inherits from Person = {

<Name=EmployeeID, Type= Number>,
<Name=DateofHire, Type=Date>,
<Name=Salary, Type= Number> }

Thus, as defined above the Employee schema has the following properties: Name, Address, DateofBirth, EmployeeID, DateofHire and Salary. If the Person schema had itself inherited properties from another schema, those properties would also belong to Employee.

In various embodiments, nodes have names/identifiers and can be specified programmatically or addressed using a path that designates the node's location in a VCR namespace. By way of illustration, the path can specify a path from the federated root (‘/’) to the node in question (‘c’):
/a/b/c

In this example, the opening ‘/’ represents the federated root, ‘a’ represents a repository beneath the federated root, ‘b’ is a hierarchy node within the ‘a’ repository, and ‘c’ is the node in question. The path can also identify a property (“property1”) on a node:
/a/b/c.property1

In aspects of these embodiments, the path components occurring prior to the node name can be omitted if the system can deduce the location of the node based on context information.

In various embodiments, a schema defined in one repository or the VCR can inherit from one or more schemas defined in the same repository, a different repository or the VCR. In certain aspects of these embodiments, if one or more of the repositories implicated by an inherited schema do not support inheritance, the inheriting schema can be automatically defined in the VCR by the API. In one embodiment, the inheriting schema is defined in the VCR by default.

By way of illustration, the Employee schema located in the Avitech repository inherits from the Person schema located beneath the Schemas hierarchy node in the BEA repository:

Schema /Avitech/Employee inherits from /BEA/Schemas/Person = {

<Name=EmployeeID, Type= Number>,
<Name=DateofHire, Type=Date>,
<Name=Salary, Type= Number> }

In various embodiments, the link property type (see Table 1) allows for content reuse and the inclusion of content that may not be under control of the VCR. By way of illustration, the value associated with a link property can refer/point to any of the following: a content node in a VCR, an individual property on a content node in a VCR, a file on a file system, an object identified by a URL (Uniform Resource Locator), or any other suitable identifier. In various embodiments, when editing a content node that has a link property type, a user can specify the link destination (e.g., using a browser-type user interface). In certain aspects of these embodiments, if a link refers to a content node or a content node property that has been moved, the link can be resolved automatically by the system to reflect the new location.

In various embodiments, a value whose type is lookup (see Table 1) can hold an expression that can be evaluated to search the VCR for instances of content node(s) that satisfy the expression. Nodes that satisfy the expression (if any) can be made available for subsequent processing. In various embodiments, a lookup expression can contain one or more expressions that can substitute expression variables from: the content node containing the lookup property, a user profile, anything in the scope of a request or a session. In various embodiments, an expression can include mathematical, logical and Boolean operators, function/method invocations, macros, SQL (Structured Query Language), and any other suitable query language. In various embodiments, an expression can be pre-processed one or more times to perform variable substitution, constant folding and/or macro expansion. It will be apparent to those of skill in the art that many other types of expressions are possible and fully within the scope and spirit of this disclosure.

In various embodiments, when editing a content node that has a lookup property type, the user can edit the expression through a user interface that allows the user to build the expression by either entering it directly and/or by selecting its constituent parts. In addition, the user interface can enable the user to preview the results of the expression evaluation.

Database mapped property types (see Table 1) allow information to be culled (i.e., mapped) from one or more database tables (or other database objects) and manipulated through node properties. By way of illustration, a company might have “content” such as news articles stored as rows in one or more RDBMS (Relational Database Management System) tables. The company might wish to make use of this “content” via their portal implementation. Further, they might wish to manage the information in this table as if it existed in the VCR. Once instantiated, a content node property that is of the database mapped type behaves as though its content is in the VCR (rather than the database table). In one embodiment, all API operations on the property behave the same but ultimately operate on the information in the database table.

In various embodiments, a given database mapped property type can have an expression (e.g., SQL) which, when evaluated, resolves to a row and a column in a database table (or resolves to any kind of database object) accessible by the system over one or more networks. A database mapped property will be able to use either native database tables/objects or database views on those tables/objects. It will be appreciated by those of skill in the art that the present disclosure is not limited to any particular type of database or resolving expression.

In aspects of certain embodiments, a schema can be automatically created that maps to any row in a database table. The system can inspect the data structure of the table and pre-populate the schema with database mapped properties corresponding to columns from the table. The table column names can be used as the default property names and likewise the data type of each column will determine the data type of each corresponding property. The system can also indicate in the schema which properties correspond to primary key columns. If certain columns from the table are not to be used in the new schema, they can be un-mapped (i.e. deselected) by a user or a process. A content node can be based on such a schema and can be automatically bound to a row in a database table (or other database object) when it is instantiated. In various embodiments, a user can interactively specify the database object by browsing the database table.

While not required by all embodiments, some embodiments employ a display template (or “template”) to display content based on a schema. Templates can implement various “views”. By way of illustration, views could be “full”, “thumbnail”, and “list” but additional “views” could be defined by end-users. A full view can be the largest, or full page view of the content. A thumbnail view would be a very small view and a list view can be used when displaying multiple content nodes as a “list” on the page (e.g., a product catalog search results page). In various embodiments, the association between a schema and templates can be one-to-many. A template can be designated as the default template for a schema. In certain of these embodiments, templates can be designed with the aid of an integrated development environment (IDE). It is noteworthy that template technology is not limited to web applications. Other delivery mechanisms such as without limitation mobile phones, XML, and the like can be enabled by this technology.

In various embodiments and by way of illustration, display templates can be implemented using HTML (Hypertext Markup Language) and JSP (Java® Server Pages). By way of a further illustration, such a display template can be accessed from a web page through a JSP tag that can accept as an argument the identifier of a content node. Given the content node, the node's schema and associated default display template can be derived and rendered. Alternatively, the JSP tag can take an additional argument to specify a view other than the default. In another embodiment, display templates can be automatically generated (e.g., beforehand or dynamically at run-time) based on a content node's schema. In other embodiments, the view (e.g., full, thumbnail, list) can be determined automatically based on the contents of an HTTP request.

In various embodiments, a role is a dynamic set of users. By way of illustration, a role can be based on functional responsibilities shared by its members. In aspects of these embodiments, a role can be defined by one or more membership criteria. Role mapping is the process by which it is determined whether or not a user satisfies the membership criteria for a given role. For purposes of discussion, a role can be described as follows:
Role=PMembers+[Membership Criteria]
   where PMembers is a set of user(s), group(s) and/or other role(s) that form a pool of potential members of this role subject to the Membership Criteria, if any. A user or a process can be in a role, if that user or process belongs to PMembers or satisfies the Membership Criteria. It is noteworthy that a user or process does not need to be a member of PMembers to be considered a member of the role. For example, it is possible to define a role with a criterion such as: “Only on Thursdays” as its membership criteria. All users would qualify as a member of this role on Thursdays. The Membership Criteria can include one or more conditions. By way of illustration, such conditions can include, but are not limited to, one or more (possibly nested and intermixed) Boolean, mathematical, functional, relational, and/or logical expressions. By way of illustration, consider the following Administrator role:
Administrator=Joe, Mary, SuperUser+CurrentTime>5:00pm

The role has as its potential members two users (Joe and Mary) and users belonging to the user group named SuperUser. The membership criteria includes a condition that requires the current time to be after 5:00 pm. Thus, if a user is Joe, Marry or belongs to the SuperUser group, and the current time is after 5:00 pm, the user is a member of the Administrator role.

In various embodiments, roles can be associated with Resource(s). By way of illustration, a resource can be any system and/or application asset (e.g., VCR nodes and node properties, VCR schemas and schema properties, operating system resources, virtual machine resources, J2EE application resources, and any other entity that can be used by or be a part of software/firmware of some kind). Typically, resources can be arranged in one or more hierarchies such that parent/child relationships are established (e.g., the VCR hierarchical namespace and the schema inheritance hierarchy). In certain of these embodiments, a containment model for roles is followed that enables child resources to inherit roles associated with their parents. In addition, child resources can override their parents' roles with roles of their own.

In various embodiments, Membership Criteria can be based at least partially on a node's properties. This allows for roles that can compare information about a user/process to content in the VCR, for example. In various embodiments, a node's property can be programmatically accessed using dot notation: Article. Creator is the Creator property of the Article node. By way of illustration, assume an Article node that represents a news article and includes two properties: Creator and State. A system can automatically set the Creator property to the name of the user that created the article. The State property indicates the current status of the article from a publication workflow standpoint (e.g., whether the article is a draft or has been approved for publication). In this example, two roles are defined (see Table 2).

TABLE 2
Exemplary Roles in an Embodiment

| ROLE | ASSOCIATED | | MEMBERSHIP |
|---|---|---|---|
| NAME | WITH | PMEMBERS | CRITERIA |
| Submitter | Article | Article.Creator | Article.State = |
| | | | Draft |
| Approver | Article | Editor | Article.State = |
| | | | (Submitted or |
| | | | Approved) |

The Submitter and Approver roles are associated with the Article node. Content nodes instantiated from this schema will inherit these roles. If a user attempting to access the article is the article's creator and the article's state is Draft, the user can be in the Submitter role. Likewise, if a user belongs to an Editor group and the article's state is Submitted or Approved, then the user can belong to the Approver role.

In various embodiments, a policy can be used to determine what capabilities or privileges for a given resource are made available to the policy's Subjects (e.g., user(s), group(s) and/or role(s)). For purposes of discussion, a policy can be described as follows:
Policy=Resource+Privilege(s)+Subjects+[Policy Criteria]

Policy mapping is the process by which Policy Criteria, if any, are evaluated to determine which Subjects are granted access to one or more Privileges on a Resource. Policy Criteria can include one or more conditions. By way of illustration, such conditions can include, but are not limited to, one or more (possibly nested and intermixed) Boolean, mathematical, functional, relational, and/or logical expressions. Aspects of certain embodiments allow policy mapping to occur just prior to when an access decision is rendered for a resource.

Similar to roles, in certain of these embodiments a containment model for policies is followed that enables child resources to inherit policies associated with their parents. In addition, child resources can override their parents' polices with policies of their own.

In various embodiments, policies on nodes can control access to privileges associated with the nodes. By way of illustration, given the following policies:
Policyl=Printer504+Read/View+Marketing
Policy2=Printer504+All+Engineering

the Marketing role can read/view and browse the Printer504 resource whereas the Engineering role has full access to it (“All”). These privileges are summarized in Table 3. Policy1 allows a user in the Marketing role to merely view the properties of Printer504 whereas Policy2 allows a user in the Engineering role to view and modify its properties, to create content nodes based on Printer504 (assuming it is a schema), and to delete the resource.

TABLE 3
Exemplary Privileges for a “Printer504” Node
in Various Embodiments

| | | READ/ | | | |
|---|---|---|---|---|---|
| ROLE | CREATE | VIEW | UPDATE | DELETE | BROWSE |
| Marketing | | x | | | x |
| Engineering | X | x | x | X | x |

Aspects of certain of these embodiments include an implied hierarchy for privileges wherein child privilege(s) of a parent privilege are automatically granted if the parent privilege is granted by a policy.

In various embodiments, the containment models for polices and roles are extended to allow the properties of a node to inherit the policies and roles that are incident on the node. Roles/polices on properties can also override inherited roles/polices. For purposes of illustration, assume the following policy on a Power property of Printer504:
Policy3=Printer504.Power+Update+Marketing

In Policy3, the Marketing role is granted the right to update the Power property for the printer resource Printer504 (e.g., control whether the printer is turned on or off). By default, the Read/View property is also granted according to an implied privilege hierarchy. (There is no Browse privilege for this property.) See Table 4. Alternatively, if there was no implied privilege hierarchy, the Power property would inherit the read/view privilege for the Marketing role from its parent, Printer504. Although no policy was specified for the Power property and the Engineering role, the privileges accorded to the Engineering role can be inherited from a parent node. These privileges are summarized in Table 4.

TABLE 4
Exemplary Privileges for the “Power” Property
in the “Printer504” Node

| ROLE | CREATE | READ/VIEW | UPDATE | DELETE |
|---|---|---|---|---|
| Marketing | | X | x | |
| Engineering | X | X | x | x |

In various embodiments, the ability to instantiate a node based on a schema can be privileged. This can be used to control which types of content can be created by a user or a process. By way of illustration, assume the following policy:
Policy4=Press_Release+Instantiate+Marketing, Manager

Policy4 specifies that nodes created based on the schema Press_Release can only be instantiated by users/processes who are members of the Marketing and/or Manager roles. In aspects of certain of these embodiments, user interfaces can use knowledge of these policies to restrict available user choices (e.g., users should only be able to see and choose schemas on which they have the Instantiate privilege).

In various embodiments, policies can be placed on schemas. For purposes of illustration, assume the following policies:
Policy5=Press_Release+Read/View+Everyone

Policy6=Press_Release+All+Public_Relations

TABLE 5
Exemplary Privileges for the “Press Release” Schema

| | CREATE | READ/ | | | |
|---|---|---|---|---|---|
| ROLE | INSTANCE | VIEW | UPDATE | DELETE | BROWSE |
| Everyone | | X | | | x |
| Public | X | X | x | x | x |
| Relations | | | | | |

With reference to Table 5 and by way of illustration, assume a content node instance was created based on the Press Release schema. By default, it would have the same roles/polices as the Press Release schema. If a policy was added to the node giving a role “Editor” the privilege to update the node, the result would be additive. That is, Everyone and Public Relations would maintain their original privileges.

In various embodiments, policies can be placed on properties within a schema, including property choices. (Property choices are a predetermined set of allowable values for a given property. For example, a “colors” property could have the property choices “red”, “green” and “blue”.)

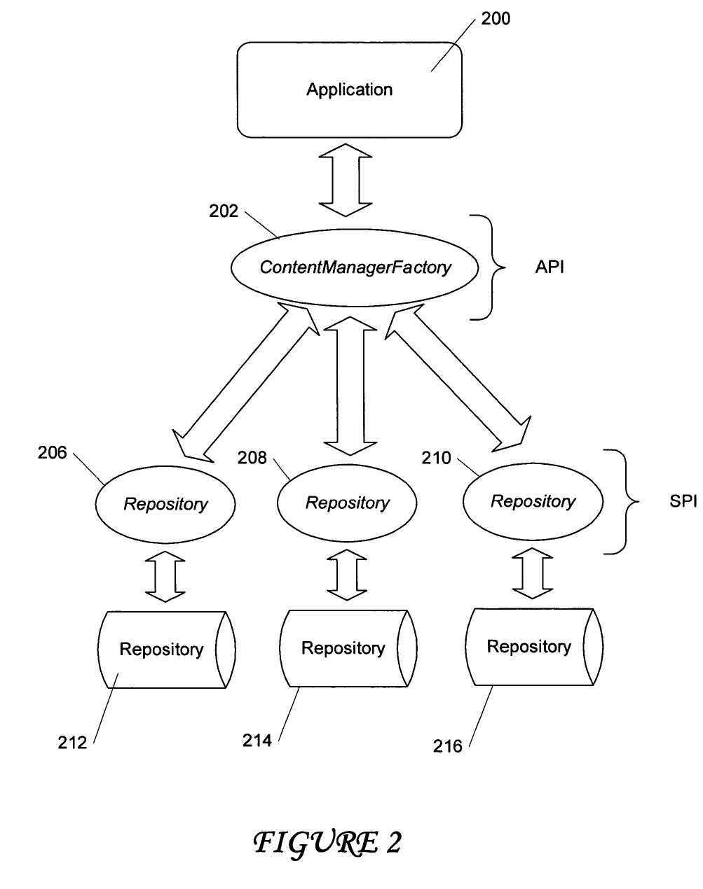

FIG. 2 is an exemplary illustration of objects/interfaces that can be used to interface repositories comprising content in various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

The ContentManagerFactory 202 can serve as a representation of an access device from an application program's 200 point of view. In aspects of these embodiments, the ContentManagerFactory attempts to connect all available repositories to the device (e.g., 212-216); optionally with user or process credentials. In various embodiments, this can be based on the Java™ Authentication and Authorization Service (available from Sun Microsystems, Inc.). Those of skill in the art will recognize that many authorization schemes are possible without departing from the scope and spirit of the present disclosure. An SPI Repository object 206-210 represents each available content repository. In an embodiment, the ContentManagerFactory can invoke a connect( ) method on the set of Repository objects. It is noteworthy that, in some embodiments, the notion of “connecting” to a repository is not exposed to users. In various embodiments, the ContentManagerFactory returns a list of repository session objects to the application program, one for each repository for which a connection was attempted. Any error in the connection procedure can be described by the session object's state. In another embodiment, the ContentManagerFactory can connect to a specific repository given the repository name. In various embodiments, the name of a repository can be a URI (uniform resource identifier).

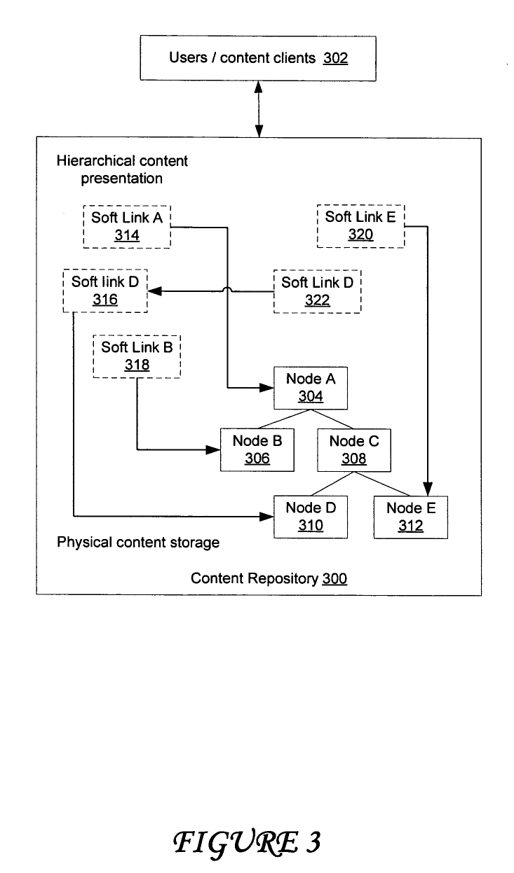

FIG. 3 is an exemplary illustration of soft links within a content repository, in accordance with various embodiments. Although this diagram may depict components as logically separate, such depiction is merely for illustrative purposes. It will be apparent to those skilled in the art that the components portrayed in this or other figures can be combined or divided into separate software, firmware and/or hardware components. Furthermore, it will also be apparent to those skilled in the art that such components, regardless of how they are combined or divided, can execute on the same computing device or can be distributed among different computing devices connected by one or more networks or other suitable communication means.

As illustrated, a content repository 300 can physically store data in a plurality of nodes such as nodes A-D (304-312) in a hierarchical structure. This hierarchical structure can be akin to a directory structure of a file system and can consist of various folders that contain nodes or other folders. The content nodes can store data in the form of binary property values containing actual data, and can also have metadata for describing various aspects about each node. A node can be of a specific content type that specifies the properties of that node. In the hierarchy, nodes can be associated via a parent/child type of relationship. For example, Node A 304 is referred to as a parent of node C 308, which is in turn a parent of Node D 310 and a child of node A 304.

A set of soft links can also be maintained within the content repository 300. Each soft link can be implemented by the repository as a skeleton shell of a node, containing no storage data, but instead containing a reference pointer to an actual node. In one embodiment, each soft link cannot contain any data except to point to the actual node containing the content.

In certain embodiments, nested soft links can also be supported. In the case of nested soft links, the pointer of one soft link references another soft link which references a node or yet another soft link and so on. There is no set limit to the depth of the nested soft link hierarchy within the repository. However, in some embodiments, a check for cyclical soft links can be performed. For example, users that reference a soft link which has already been included in the path of pointers could create a cyclical infinite loop. Thus, a situation in which soft link A references B, which references C, which in turn references A again, may be undesirable. The system can incorporate a check to prevent such infinite loops.

In some embodiments, each soft link is presented to the users 302 as a pointer to a regular node. This can provide various advantages. For example, users can perform various operations such as accessing the data contained in the node as though they were dealing directly with the content node. Furthermore, users may structure their own hierarchical directories of data as they see fit, without the need to duplicate the nodes nor the actual data maintained by each node. For example, a user may wish to batch a list of appointments by month in one folder while other users may wish to batch a list of the same (or other) appointments by topic in another folder. Soft links can allow such arrangement without the need to duplicate data. As an illustration, one user can choose to create a separate hierarchy where node D is located below node A and node B is in turn located beneath node D. Rather than creating copies of each node and storing them in a separate directory within the repository, this user can instead create the corresponding soft links, such as soft links A, D and B (314, 316, and 318 respectively) which contain no actual data but instead reference the appropriate nodes such that the user can access and manage the data contained therein. Other users are also enabled to create their own hierarchies without duplicating and maintaining more data. For example, soft links E and D (320, 322) can be created for referencing nodes E and D within the content repository. It should be noted that soft link D 322 could reference another soft link D 316 which in turn references the actual node D 310 that physically stores various data needed by the user. This is referred to as a nested soft link.

In one embodiment, a soft link is resolved by the content repository, such as BEA Content repository available from BEA Systems, Inc. This can be done by traversing down the path of appropriate references of each link until a concrete content storage item (e.g. node) is reached. In alternative embodiments, soft links can be resolved by other repositories and entities. In one embodiment, a soft link should reference only one node and thus implement a one-to-one type of relationship.

Soft links can also enable users to query the repository for various types of information. For example, users can determine which soft links refer to a specific node before deleting the node, in order to maintain structural integrity of the various hierarchies. In one embodiment, deleting a soft link to a node will not delete the actual content node. In this manner, the structural hierarchy need not be enforced by the content repository but can be left to manage for the users and developers.

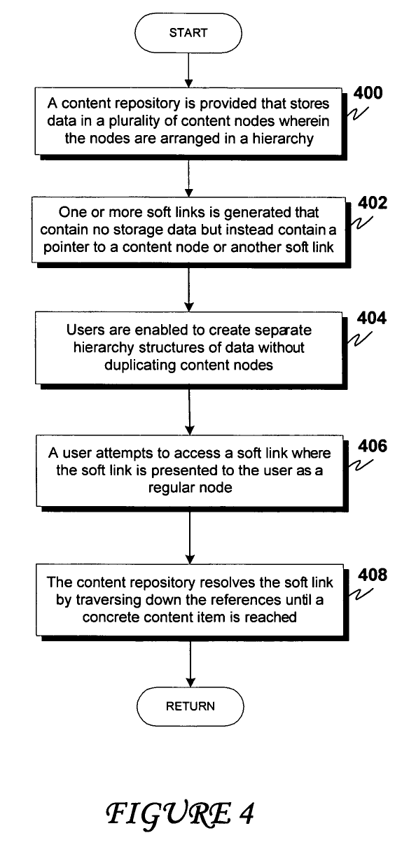

FIG. 4 is an exemplary flow diagram illustration of using soft links for managed content within a repository, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

As shown in step 400, a content repository can be provided, which stores data in a plurality of content nodes wherein the nodes are arranged in a hierarchy. Each node can contain binary property values (e.g. files, documents, etc.) as well as metadata for describing the node. As illustrated in step 402, a soft link can be generated that contain no storage data but instead contain a reference to a content node or another soft link. By using such soft links, users are enabled to create separate hierarchy structures of data without duplicating content nodes, as shown in step 404. In one embodiment, soft links can be presented to users as pointers to regular content nodes. In step 406, a user attempts to access a soft link that is presented to that user as a pointer to a regular node. In step 408, the references of the soft link can be resolved by the content repository such as by traversing the path of the references until a concrete node is determined. This concrete node and any data it contains can thus be presented to the user. In various embodiments, a soft link can point to any node within the repository, whether it has metadata and binary property values or not.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the machine readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing mechanisms and methods for [] as discussed herein.

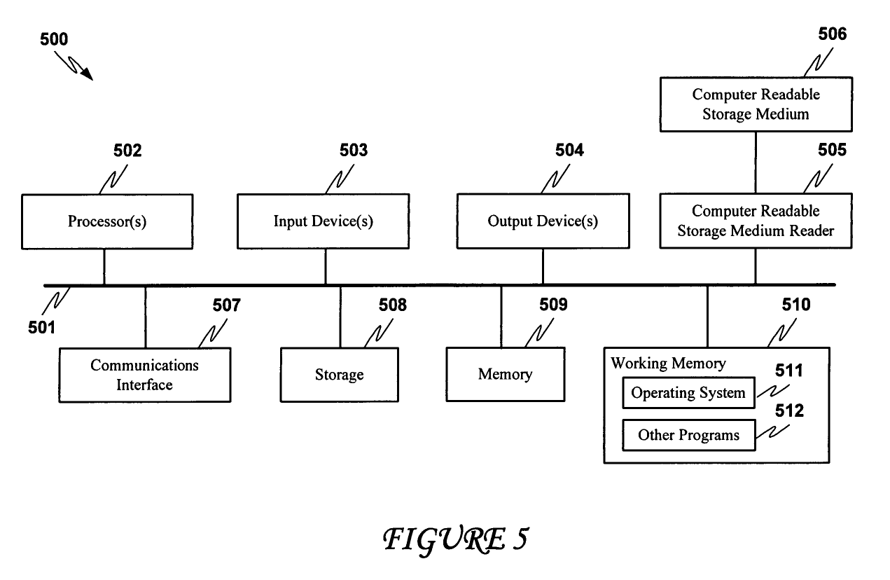

FIG. 5 illustrates an exemplary processing system 500, which can comprise one or more of the elements of FIG. 1. Turning now to FIG. 5, an exemplary computing system is illustrated that may comprise one or more of the components of FIG. 1. While other alternatives might be utilized, it will be presumed for clarity sake that components of the systems of FIG. 1 are implemented in hardware, software or some combination by one or more computing systems consistent therewith, unless otherwise indicated.

Computing system 500 comprises components coupled via one or more communication channels (e.g., bus 501) including one or more general or special purpose processors 502, such as a Pentium®, Centrino®, Power PC®, digital signal processor (“DSP”), and so on. System 500 components also include one or more input devices 503 (such as a mouse, keyboard, microphone, pen, and so on), and one or more output devices 504, such as a suitable display, speakers, actuators, and so on, in accordance with a particular application. (It will be appreciated that input or output devices can also similarly include more specialized devices or hardware/software device enhancements suitable for use by the mentally or physically challenged.)

System 500 also includes a machine readable storage media reader 505 coupled to a machine readable storage medium 506, such as a storage/memory device or hard or removable storage/memory media; such devices or media are further indicated separately as storage 508 and memory 509, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 507 may also be included, such as a modem, DSL, infrared, RF or other suitable transceiver, and so on for providing inter-device communication directly or via one or more suitable private or public networks or other components that may include but are not limited to those already discussed.

Working memory 510 further includes operating system (“OS”) 511 elements and other programs 512, such as one or more of application programs, mobile code, data, and so on for implementing system 500 components that might be stored or loaded therein during use. The particular OS or OSs may vary in accordance with a particular device, features or other aspects in accordance with a particular application (e.g. Windows®, WindowsCE™, Mac™, Linux, Unix or Palm™ OS variants, a cell phone OS, a proprietary OS, Symbian™, and so on). Various programming languages or other tools can also be utilized, such as those compatible with C variants (e.g., C++, C#), the Java™ 2 Platform, Enterprise Edition (“J2EE”) or other programming languages in accordance with the requirements of a particular application. Other programs 512 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 508 or memory 509) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for using soft links with managed content, said method comprising:
storing data within a content repository, said content repository containing said data in a plurality of content nodes arranged in a hierarchy structure;
creating at least one soft link and associating said soft link with one of said plurality of content nodes of the content repository, said soft link containing a reference pointer to said one of said plurality of content nodes or to a second soft link;
accessing said soft link by one or more users; and
resolving said soft link by said repository by traversing down said reference pointer until said one of said plurality of content nodes is reached.

2. The method according to claim 1 wherein said creating a soft link and associating said soft link with the one of said plurality of content nodes further includes:
creating a new hierarchy structure by said one or more users, said new hierarchy structure including a plurality of soft links, said plurality of soft links referencing said plurality of content nodes within the content repository.

3. The method according to claim 1 wherein said soft link is implemented as a skeleton node within said plurality of content nodes, said skeleton node containing no storage data except to point to the content node associated with said soft link.

4. The method according to claim 1 wherein said soft link is presented to said one or more users as pointer to a regular content node from said plurality of content nodes arranged in the hierarchy structure, such that said one or more users are able to access data contained by said regular content node.

5. The method according to claim 1, further comprising:
constructing a query by said one or more users, said query determining which soft links point to a specified soft link.

6. The method according to claim 1 wherein creating at least one soft link and associating said soft link with one of said plurality of content nodes of the content repository further includes:
performing a cyclical infinite loop check to prevent a first soft link from referencing a second soft link if said second soft link already references said first soft link directly or via any intermediate soft links.

7. The method according to claim 1 wherein deleting a soft link will not delete the content node associated with said soft link.

8. A system for using soft links with managed content, said system comprising:
a content repository for storing data in a plurality of content nodes, said content nodes arranged in a hierarchy structure;
at least one soft link created within said content repository and associated with one of said plurality of content nodes of the content repository, said soft link containing a reference pointer to said one of said plurality of content nodes or to a second soft link;
wherein said soft link is automatically resolved by said repository upon a user attempting to access said soft link, by traversing down said reference pointer until said one of said plurality of content nodes is reached.

9. The system according to claim 8, further comprising:
a new hierarchy structure created by said user, said new hierarchy structure including a plurality of soft links, said plurality of soft links referencing said plurality of content nodes within the content repository.

10. The system according to claim 8 wherein said soft link is implemented as a skeleton node within said plurality of content nodes, said skeleton node containing no storage data except to point to the content node associated with said soft link.

11. The system according to claim 8 wherein said soft link is presented to said user as pointer to a regular content node from said plurality of content nodes arranged in the hierarchy structure, such that said user is able to access data contained by said regular content node.

12. The system according to claim 8, further comprising:
a query constructed by said user, said query determining which soft links point to a specified soft link.

13. The system according to claim 8 wherein creating at least one soft link and associating said soft link with one of said plurality of content nodes of the content repository further includes:
performing a cyclical infinite loop check to prevent a first soft link from referencing a second soft link if said second soft link already references said first soft link directly or via any intermediate soft links.

14. The system according to claim 8 wherein deleting a soft link will not delete the content node associated with said soft link.

15. A computer readable medium having instructions stored thereon, which when executed by one or more processors, cause a system to:
store data within a content repository, said content repository containing said data in a plurality of content nodes arranged in a hierarchy structure;
create at least one soft link and associate said soft link with one of said plurality of content nodes of the content repository, said soft link containing a reference pointer to said one of said plurality of content nodes or to a second soft link;
access said soft link by one or more users; and
resolve said soft link by said repository by traversing down said reference pointer until said one of said plurality of content nodes is reached.

16. The computer readable medium according to claim 15 wherein said instructions for creating a soft link and associating said soft link with the one of said plurality of content nodes further include instructions that cause the system to:
create a new hierarchy structure by said one or more users, said new hierarchy structure including a plurality of soft links, said plurality of soft links referencing said plurality of content nodes within the content repository.

17. The computer readable medium according to claim 15 wherein said soft link is implemented as a skeleton node within said plurality of content nodes, said skeleton node containing no storage data except to point to the content node associated with said soft link.

18. The computer readable medium according to claim 15 wherein said soft link is presented to said one or more users as pointer to a regular content node from said plurality of content nodes arranged in the hierarchy structure, such that said one or more users are able to access data contained by said regular content node.

19. The computer readable medium according to claim 15 wherein a query is constructed by said one or more users, said query determining which soft links point to a specified soft link.

20. The computer readable medium according to claim 15 wherein instructions for creating at least one soft link and associating said soft link with one of said plurality of content nodes of the content repository further include instructions to cause the system to:
perform a cyclical infinite loop check to prevent a first soft link from referencing a second soft link if said second soft link already references said first soft link directly or via any intermediate soft links.
